(19) United States
(12) Patent Application Publication
(10) Pub. No.: US 2014/0330768 A1
(43) Pub. Date: Nov. 6, 2014

(54) INCREMENTALLY UPDATED SAMPLE TABLES

(71) Applicant: HEWLETT-PACKARD DEVELOPMENT COMPANY, L.P., (US)

(72) Inventors: Hansjorg Zeller, Palo Alto, CA (US); QiFan Chen, Austin, TX (US); Ramakumar Kosuru, Austin, TX (US); Choudur Lakshminarayan, Austin, TX (US); Barry Lynn Fritchman, Lake Forest, CA (US)

(73) Assignee: HEWLETT-PACKARD DEVELOPMENT COMPANY, L.P., Houston, TX (US)

(21) Appl. No.: 13/875,046

(22) Filed: May 1, 2013

(51) Int. Cl. G06F 17/30

(52) U.S. Cl. CPC G06F 17/30289
USPC 707/609

(57) ABSTRACT

An example apparatus may include a processor and a memory device including computer program code. The memory device and the computer program code may be for, with the processor, causing the apparatus to delete, in a sample table, rows corresponding to a predicate, wherein rows in the sample table are representative of a random sample of rows in a base table of a database; generate sample rows representative of a random sample of rows in the base table corresponding to the predicate; and add the sample rows to the sample table to generate an incrementally updated sample table.

### BACKGROUND

Databases are collections of data or information that may be organized according to various parameters. Each database may include one or more tables of data, each table including zero or more rows and one or more columns of data. Each row represents a record, and each column represents a field, or attribute.

### BRIEF DESCRIPTION OF THE DRAWINGS

For a more complete understanding of various examples, reference is now made to the following descriptions taken in connection with the accompanying drawings in which:

FIG. 1 illustrates an example system;

FIG. 2 provides an example illustration of updating of a sample table;

FIG. 3 is a flow chart illustrating an example method; and

FIG. 4 illustrates an example counting Bloom filter.

### DETAILED DESCRIPTION

In various examples, histogram statistics for database tables may be updated in an efficient manner. In this regard, a base table of a database may be sampled to create a sample table which represents a random sampling of the base table. In one example, the base table may include a large number of rows (e.g., one billion), and the sample table may be created by sampling the base table at a sample rate (e.g., 1/1000). Thus, the sample table may be substantially smaller than the base table and require fewer resources (e.g., processor time) to compute histogram statistics. In this regard, in one example, statistics may be computed on the sample table and extrapolated, using statistical methods, to reflect approximate statistics of the base table. As the base table gets changed over time, the histogram statistics may potentially become more and more inaccurate and therefore should be updated occasionally. In various examples, a predicate that describes a superset of potentially changed (inserted, updated, or deleted) rows in the base table may be used in updating of the sample table. In one example, rows satisfying the predicate are deleted from the sample table, and a set of rows representing a random sampling of rows satisfying the predicate in the base table may be inserted into the sample table. Thus, the sample table may be updated to represent a random sampling of the base table without sampling the entire base table again. In various examples, the updated sample table may be used to generate updated histogram statistics.

In various examples, database systems may optimize query plans using histogram statistics. Various examples described herein may update histogram statistics in an efficient limner. Histogram statistics for a table may be determined by dividing the rows of a table into ranges of values, or intervals, for a field. In various examples, each histogram interval has approximately the same number of rows. For each histogram interval, a unique entry count (UEC) may be determined and maintained. Various other statistics for each histogram interval may also be maintained. The histogram statistics may be useful in providing various characteristics of the database or the database tables, and the statistics may be useful in optimizing query plans.

The histogram statistics may be updated regularly or at select times. For large databases or large tables, the updating may be highly resource intensive. Various examples described herein allow updating of histogram statistics in an efficient manner.

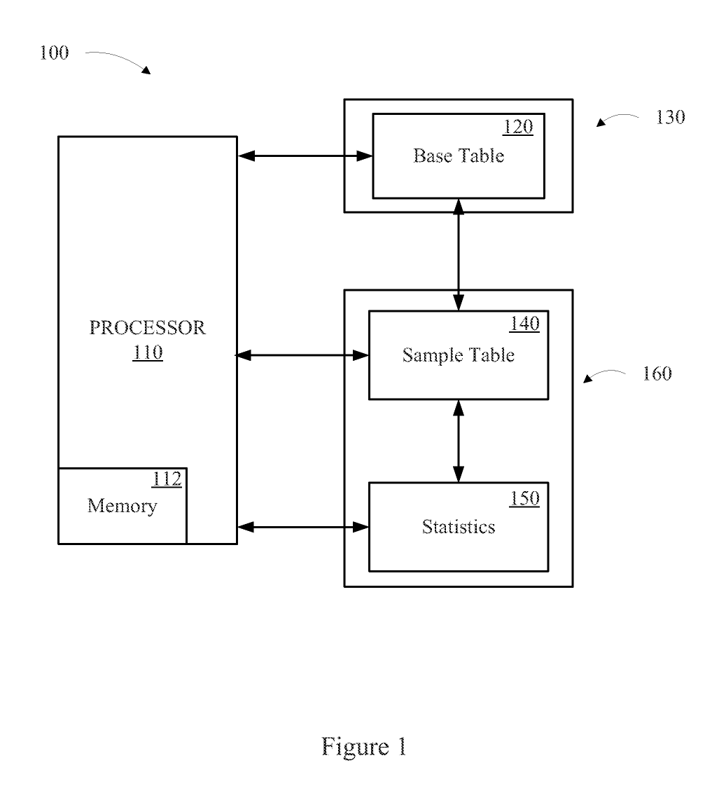

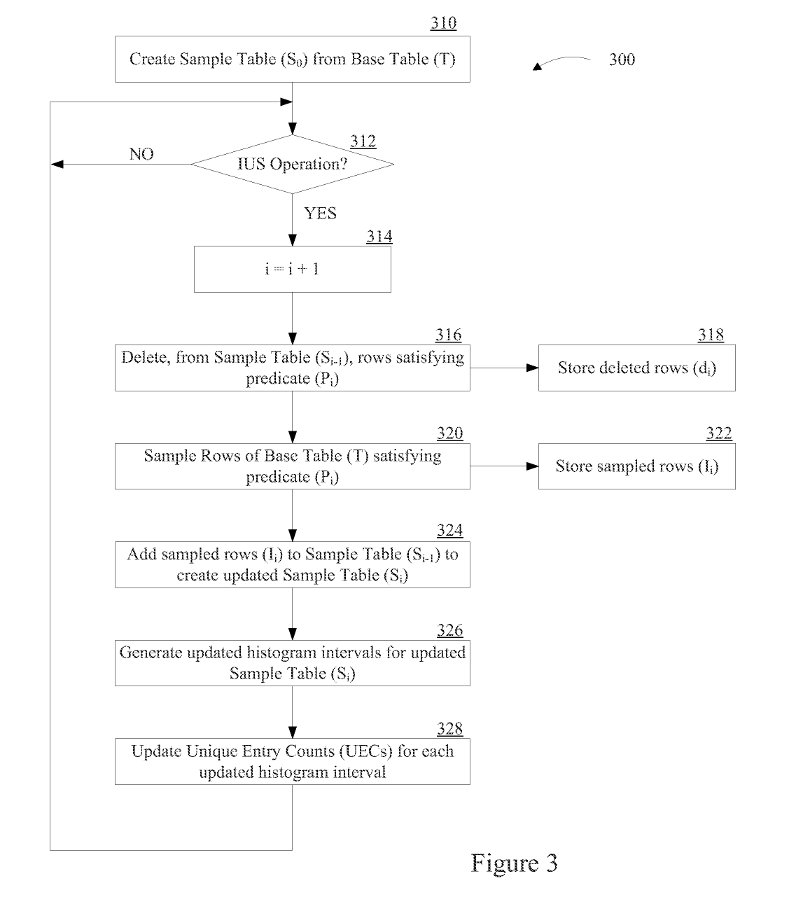

Referring first to FIG. 1, an example system is illustrated. The example system 100 of FIG. 1 includes a processor 110 which may have a non-transitory memory device 112. In various examples, the memory device 112 may be integrally formed with the processor 110 or may be an external memory device. The memory device 112 may include program code that may be executed by the processor. For example, one or more processes may be performed to execute the example method, or portions thereof, described below with reference to FIG. 3.

The example system 100 may further include a base table 120 which may include various rows and columns, for example. The columns may represent various fields, or attributes, of the base table 120 or a database. In various examples, the base table 120 may be part of a database 130 which may be stored on a memory device (not shown). The database 130 may include any number of tables, each of which may include various rows and columns. In various examples, the base table 120 may include a large number of rows. For example, in an enterprise environment, an example base table 120 may include rows numbering in the millions, hundreds of millions, billions, or more.

In various examples, the system 100 may include a sample table 140 and various statistics 150. In one example, the sample table 140 may be representative of a random sampling of the base table 120 and may include fewer rows than the base table 120. The number of rows in the sample table 140 may depend upon a sampling rate used to generate the sample table 140. In various examples, the sampling rate may be 1/1000, 1/100, or any other selected rate. The sampling rate may be selected to balance efficiency of updating histogram statistics e.g., reducing the size of the sample table) and accuracy of random representation.

The statistics 150 may include histogram statistics. In various examples, various other statistics may also be included. For example, the statistics 150 may include skew elements associated with the histogram statistics. In the example system 100 of FIG. 1, the sample table 140 and the statistics are maintained in a persistent memory 160. In various examples, sample table 140, the statistics 150 and the database 130 may be retained in the same persistent memory.

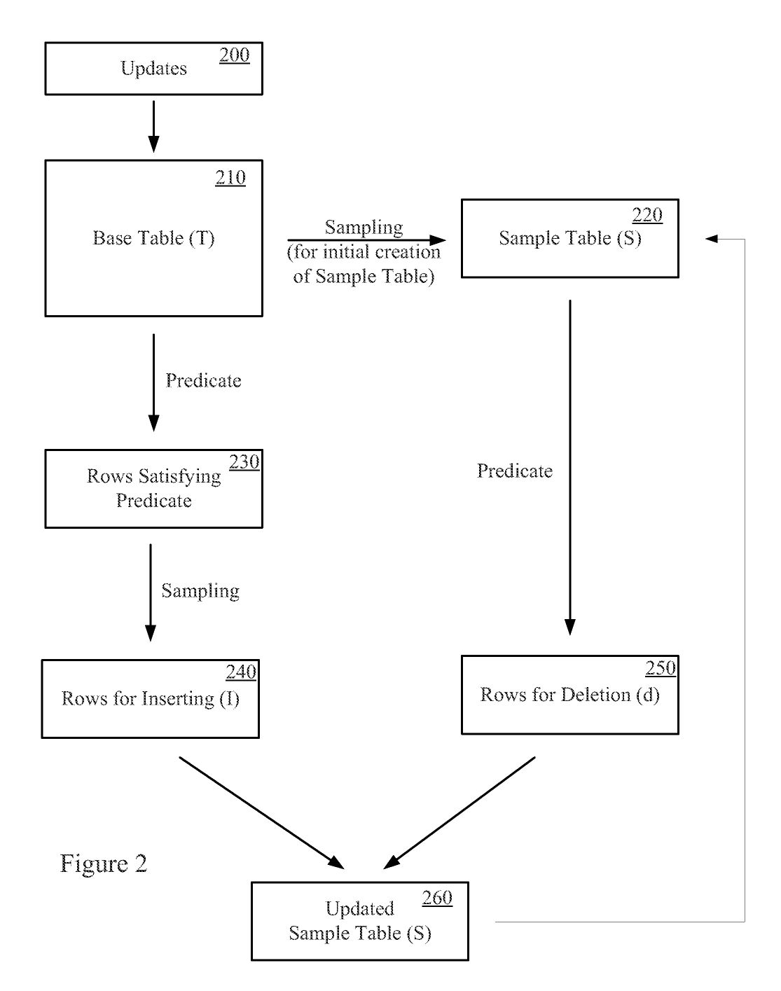

Referring now to FIG. 2, an example illustration of the updating of a sample table, such as the sample table 140 of FIG. 1, is provided. As noted above, a sample table (S) 220 may be created by sampling of a base table (T). In this regard, the sample table 220 may be a representation of a random sampling of the base table 210. The size of the sample table 220 may depend on the size of the base table 210 and the sampling rate.

In accordance with various examples described herein, the complete base table 210 may be sampled only when initially creating the sample table 220. Thereafter, while the base table 210 may be updated due to, for example, addition, deletion, or changing of data in the base table (e.g., as illustrated in the example of FIG. 2 with updates 200), only certain portions of the base table may be sampled, as described in detail below, in updating the sample table.

In various examples, the sample table may be updated when, for example, an incremental update statistics (IUS) algorithm may be executed. Various examples may execute the algorithm at varying frequencies which may depend on the purpose of the update or the type of database, for example. In one example, the database may include information related to sales transactions, and statistics may be updated on a daily basis.

In various examples, a predicate may be used to efficiently update the sample table and, as described below with reference to FIG. 3, to efficiently update various statistics associated with the table and/or a database containing the table. In this regard, in some examples, the predicate may be a condition, a threshold, or other criteria. In the example described above related to sales transactions, the statistics may be updated daily, and the predicate may be, for example, sale transactions within the last seven days to collect sales up to seven days in the past, Applying the predicate to a table, such as the base table 210 or the sample table 220, may result in a superset of rows which may have been updated (e.g., sales transactions within the last one day). The predicate may be selected to ensure, or increase likelihood, that all updated rows are included.

In various examples, as illustrated in the example of FIG. 2, the predicate may be applied to the base table 210, resulting in a set of rows satisfying the predicate 230. Only some rows in the set of rows 230 may have been updated. Thus, in the sales transaction example and the example predicate described above, the set of rows 230 may include all rows from the base table 210 which reflect a sales transaction within the past seven days. The size of the set of rows 230 may vary based on the predicate. In various examples, the size of the set of rows 230 may be substantially smaller than the base table 210. For example, if the base table 210 includes sales transaction for the entire history of an organization or for the past year, the number of rows may be very large, while the number of rows satisfying the predicate of sales in the last seven days may be relatively very small.

The set of rows 230 from the base table 210 satisfying the predicate may be sampled to obtain a set of rows 240 for insertion into an updated sample table 260. In various examples, the sampling of the set of rows 230 may be performed in accordance with the sampling used to initially generate the sample table 220. For example, a uniform sampling rate (e.g.,) 1/1000) may be used for sampling in both cases.

In various examples, the same predicate applied to the base table 210 to produce the set of rows 230 may be applied to the sample table 220. For example, a set of rows 250 may be generated corresponding to rows from the sampled table 220 which reflect a sales transaction in the past seven days. This set of rows 250 may be the set of rows that are to be deleted from the sample table 220 for updating of the sample table.

An updated sample table 260 may be generated by deleting the set of rows 250 from the sample table 220 satisfying the predicate and inserting the set of rows 240 obtained from sampling of the set of rows 230 satisfying the predicate applied to the base table 210. In various examples, the updated sample table 260 may replace the sample table 220 for the subsequent update without the need for again sampling the entire base table 210.

In various examples, each of the tables and sets of rows 210-260 may be retained in a persistent memory. For example, the set of rows for inserting 240 and the set of rows for deletion 250 may be retained for statistical purposes.

Referring now to FIG. 3, a flow chart illustrates an example method 300 for updating a histogram statistics for a database. The updating of histogram statistics in the example method 300 of FIG. 3 may include updating a sample table, such as the updating described above with reference to FIG. 2. In this regard, a sample table (S₀) may be created from the base table (T) for which the histogram statistics are to be updated (block 310). As described above, the initial sample (S₀) table may be created by sampling of the base table. The sample table may be representative of a random sample of the base table. As noted above, the sampling rate may be selected to, for example, balance efficiency and accuracy.

Upon an indication of an execution of an incremental update statistics (IUS) operation (block 312), a counter (i) may be incremented (block 314). The counter (i) may be initially set to 0 and may be used to track historical statistics, for example.

In various examples, rows in the sample table (Sᵢ₋₁) which satisfy a predicate (pᵢ) (e.g., the set of rows 250 in FIG. 2) may be deleted from the sample table (block 316). The predicate (pᵢ) may be received as part of the IUS operation indication, for example, and may be the same or different for each update. In various examples, the predicate (pᵢ) is selected such that the resulting set of rows to be deleted includes at least the rows that are updated, deleted, or inserted. In one example, the predicate results in a set of rows that is a superset of the rows which have been updated, deleted, or inserted in the base table. Thus, the predicate results in a set of rows that includes at least rows that have been inserted, updated, or deleted and, in various examples, may include any number of rows greater than or equal to the number of rows that are inserted, updated, or deleted. In various examples, the predicate may result in a number of rows that is at least less than the number of rows in the base table. In various examples, since some of the modified rows may have been sampled and included in the sample table (Sᵢ₋₁), any such rows in the sample table are removed to avoid double sampling. The deleted set of rows (dᵢ) may be stored in a persistent memory (block 318), for example, for use in determining certain statistics through, for example, counting Bloom filters, as described in greater detail below.

In various examples, rows from the base table satisfying the predicate (e.g., the set of rows 230 in FIG. 1) may be sampled (block 320). As noted above, in various examples, the sampling is in accordance with the sampling used to create the initial sample table (e.g. block 310 of FIG. 3). In this regard, the sampling rate may be similar to the sampling rate used to create the initial sample table. In one example, the sampling rate is the same as the sampling rate used to create the initial sample table. The sampling of the rows from the base table satisfying the predicate may be representative of a random sample of rows in the base table corresponding to the predicate. The sampled rows may be stored in a persistent memory (block 322), for example, for use in determining certain statistics through the counting Bloom filters.

The sampled rows from the base table satisfying the predicate may be added to the sample table to create an updated sample table (block 324). Thus, an updated sample table may be created.

In various examples, the rows of the sample table may be divided into updated histogram intervals (block 326). In this regard, as noted above, the histogram statistics for the sample table may be determined by dividing the rows of the sample table into ranges of values, or intervals, for a field. In various examples, each histogram interval has approximately the same number of rows. For each histogram interval, a unique entry count (UEC) may be determined and maintained (block 328). In various examples, the histogram intervals may be maintained at the same boundaries, and the rows in the sample table may be reapportioned to the existing histogram intervals.

In various examples, counting Bloom filters may be used to accelerate the determination of UECs. Bloom filters may be used for tracking data set membership. Counting Bloom filters (CBFs) are a type of Bloom filter which may also be used to remove a data set from the Bloom filter. In this regard, in various embodiments, CBFs may be used to maintain the frequency information for each histogram interval.

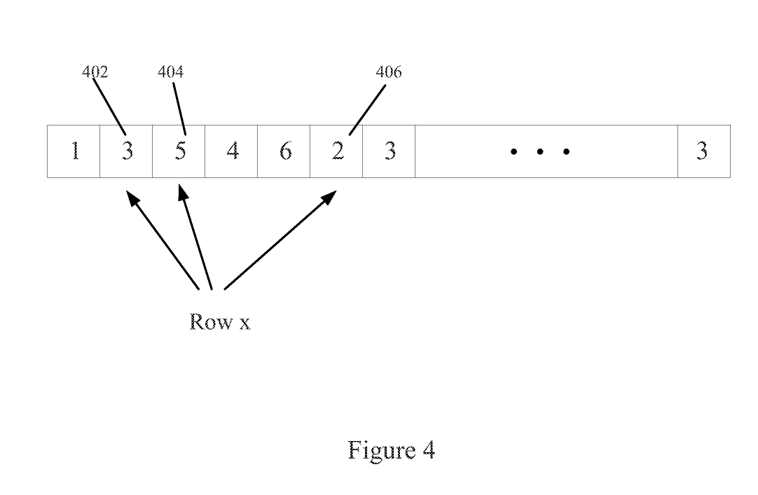

FIG. 4 illustrates an example CBF that may be used in various examples. The illustrated example CBF of FIG. 4 may be an array of m counters, each of which may be of multiple bits in length. In one example, the length of each counter is m. In the example of FIG. 4, each counter may represent the frequency of a representation of a value in the sample table. In various examples, a particular row in the sample table may be represented as contributing to a frequency in one or more counters in the CBF array. For example, in the example of FIG. 4, a value in a particular row may contribute to the frequencies represented in counters 402, 404, 406.

An example use of CBFs is described here with reference to FIG. 3. In various examples, CBF's may be maintained in a persistent memory similar to the maintenance of the sample table and other statistics-related information. At block 316, when rows are deleted from the sample table, the corresponding CBF may be kept in synchronization by decrementing frequencies due to the deleted rows. For example, in the example of FIG. 4, if the example row is deleted, the frequencies in counters 402, 404 and 406 may be decremented. At block 324, when rows are added to the sample table, the corresponding CBF may be kept in synchronization by increasing frequencies due to the addition of rows.

At block 328, in various examples, the updating of the UECs may be accelerated using the CBFs. In one example, the CBFs may be used to estimate frequencies of frequencies, which may be a measure of the occurrence of various frequencies. In this regard, a frequency of a value may be the number of times it occurs in the sample table, for example. In various examples, frequencies of frequencies may be used to estimate the UECs. In this regard, a frequency of frequencies may be the number of values that have a particular frequency.

In various examples, following the updating of UECs (e.g., block 328 of FIG. 3), a check may be performed to ensure, for example, there are no imbalances in the histogram intervals or skew elements. If the check indicates any imbalances, new histogram intervals may be computed for the sample table. Sampling of the base table may be unnecessary.

Thus, various examples allow updating of histogram statistics without resource-intensive analysis of a large base table. In various examples, use of a predicate to update a sample table that is maintained in a persistent memory allows efficient updating of the sample table and of histogram statistics. Further, in various examples, CBFs may be used to accelerate computation of UECs in the histogram statistics.

Various examples described herein are described in the general context of method steps or processes, which may be implemented in one example by a software program product or component, embodied in a machine-readable medium, including executable instructions, such as program code, executed by entities in networked environments. Generally, program modules may include routines, programs, objects, components, data structures, etc. which perform particular tasks or implement particular abstract data types. Executable instructions, associated data structures, and program modules represent examples of program code for executing steps of the methods disclosed herein. The particular sequence of such executable instructions or associated data structures represents examples of corresponding acts for implementing the functions described in such steps or processes.

Software implementations of various examples can be accomplished with standard programming techniques with rule-based logic and other logic to accomplish various database searching steps or processes, correlation steps or processes, comparison steps or processes and decision steps or processes.

The foregoing description of various examples has been presented for purposes of illustration and description. The foregoing description is not intended to be exhaustive or limiting to the examples disclosed, and modifications and variations are possible in light of the above teachings or may be acquired from practice of various examples. The examples discussed herein were chosen and described in order to explain the principles and the nature of various examples of the present disclosure and its practical application to enable one skilled in the art to utilize the present disclosure in various examples and with various modifications as are suited to the particular use contemplated. The features of the examples described herein may be combined in all possible combinations of methods, apparatus, modules, systems, and computer program products.

It is also noted herein that while the above describes examples, these descriptions should not be viewed in a limiting sense. Rather, there are several variations and modifications which may be made without departing from the scope as defined in the appended claims.

What is claimed is:

1. An apparatus, comprising:
a processor; and
a memory device including computer program code, the memory device and the computer program code for, with the processor, causing the apparatus to perform at least the following:
delete, in a sample table, rows corresponding to a predicate, wherein rows in the sample table are representative of a random sample of rows in a base table of a database;
generate sample rows representative of a random sample of rows in the base table corresponding to the predicate; and
add the sample rows to the sample table to generate an incrementally updated sample table.

2. The apparatus of claim 1, wherein the memory device further includes computer program code for causing the apparatus to:
generate updated histogram statistics based on the updated sample table.

3. The apparatus of claim 2, wherein the computer program code for causing the apparatus to generate updated histogram statistics comprises computer program code for causing the apparatus to:
generate updated histogram intervals for the updated sample table; and
update unique entry counts for each updated histogram interval.

4. The apparatus of claim 3, wherein updating the unique entry counts uses counting Bloom filters.

5. The apparatus of claim 1, wherein the memory device further includes computer program code for causing the apparatus to:
storing, in a persistent memory, at least one of the updated sample table, rows in the sample table corresponding to the predicate or the sample rows representative of a random sample of rows in the base table corresponding to the predicate.

6. The apparatus of claim 1, wherein the computer program code for causing the apparatus to delete rows comprises computer program code for causing the apparatus to:
applying the predicate to the sample table to generate a set of rows from the sample table satisfying the predicate.

7. The apparatus of claim 1, wherein the computer program code for causing the apparatus to generate sample rows comprises computer program code for causing the apparatus to:
applying the predicate to the base table to generate a set of rows from the base table satisfying the predicate.

8. A method, comprising:
applying a predicate to a base table of a database to generate a first set of rows;
sampling the first set of rows to generate a second set of rows, the second set of rows being representative of a random sample of the first set of rows;
applying the predicate to a sample table to generate a third set of rows, the sample table being representative of a random sample of the base table;
deleting the third set of rows from the sample table; and
adding the second set of rows to the sample table to generate an incrementally updated sample table.

9. The method of claim 8, further comprising:
generating updated histogram statistics based on e updated sample table.

10. The method of claim 9, wherein the generating updated histogram statistics comprises:
generating updated histogram intervals for the updated sample table; and
updating unique entry counts for each updated histogram interval.

11. The method of claim 10, wherein updating the unique entry counts uses counting Bloom filters.

12. The method of claim 8, further comprising:
storing the updated sample table in a persistent memory.

13. A computer program product, embodied on a non-transitory computer-readable medium, comprising:
computer code for deleting a first set of rows from a sample table, wherein rows in the sample table are representative of a random sample of rows in a base table of a database, the first set of rows corresponding to rows in the sample table satisfying a predicate;
computer code for generating a second set of rows by sampling rows in the base table satisfying the predicate, the second set of rows being representative of a random sample of the rows in the base table satisfying the predicate; and
computer code for adding the second set of rows to the sample table to generate an incrementally updated sample table.

14. The computer program product of claim 13, further comprising:
computer code for generating updated histogram statistics based on the updated sample table.

15. The computer program product of claim 14, wherein the computer code for generating updated histogram statistics comprises:
computer code for generating updated histogram intervals for the updated sample table; and
computer code for updating unique entry counts for each updated histogram interval.
